(19) United States
(12) Patent Application Publication
(10) Pub. No.: US 2017/0264065 A1
(43) Pub. Date: Sep. 14, 2017

(54) SLIDING-CONTACT POWER SUPPLY SYSTEM AND THREE-DIMENSIONAL CIRCULATING GARAGE HAVING THE SAME

(71) Applicant: BYD COMPANY LIMITED, Shenzhen (CN)

(72) Inventors: Tian QI, Shenzhen (CN); Jinghua TANG, Shenzhen (CN)

(21) Appl. No.: 15/505,367

(22) PCT Filed: Sep. 14, 2015
(86) PCT No.: PCT/CN2015/089557

§ 371 Date: Feb. 21, 2017

(30) Foreign Application Priority Data
Sep. 15, 2014 (CN) 201410468599.1

(51) Int. Cl. H01R 39/64; E04H 6/18; E04H 6/14

(52) U.S. Cl. CPC H01R 39/64; E04H 6/14; E04H 6/187

(57) ABSTRACT

A sliding-contact power supply system and a three-dimensional circulating garage having the same are provided. The sliding-contact power supply system includes: a plurality of sub-sliding wires, each of the plurality of sub-sliding wires being adapted to be electrically connected to an outside power supply; a plurality of insulation segmentation elements, each of the plurality of insulation segmentation elements being connected between two sub-sliding wires; and a plurality of current collectors, each of the plurality of current collectors being electrically connected to the sub-sliding wire; wherein the plurality of sub-sliding wires and the plurality of insulation segmentation elements form a sliding wire guide rail having a ring shape, and each current collector is slidably disposed on the sliding wire guide rail.

### FIELD

The present disclosure generally relates to a sliding-contact power supply system and a three-dimensional circulating garage having the same.

### BACKGROUND

In the related art, the current vertical three-dimensional circulating garage is suitable for charging multiple vehicles placed on multiple vehicle placing plates at the same time. However, since the required charging power is comparatively large, the sliding contact wire may be destroyed due to over-current.

### SUMMARY

Embodiments of the present disclosure seek to solve at least one of the problems existing in the related art to at least some extent.

According to embodiments of the present disclosure, a sliding-contact power supply system is provided. The sliding-contact power supply system includes: a plurality of sub-sliding wires, each of the plurality of sub-sliding wires being adapted to be electrically connected to an outside power supply; a plurality of insulation segmentation elements, each of the plurality of insulation segmentation elements being connected between two sub-sliding wires; and a plurality of current collectors, each of the plurality of current collectors being electrically connected to the sub-sliding wire; wherein the plurality of sub-sliding wires and the plurality of insulation segmentation elements define a sliding wire guide rail having a ring shape, and each current collector is slidably disposed on the sliding wire guide rail.

With the sliding-contact power supply system according to embodiments of the present disclosure, by supplying power through multiple points and multiple segments, an electric current passing through each sub-sliding wire can be reduced, and each sub-sliding wire cannot influence one other, so that the whole system can run normally and safely, and it is convenient for maintenance and troubleshooting of the whole system. And also, a requirement for high-power current of mobile device can be satisfied.

According to other embodiments of the present disclosure, a three-dimensional circulating garage is provided. The three-dimensional circulating garage includes the sliding-contact power supply system mentioned above. Thus, a safety performance and stability of the three-dimensional circulating garage can be improved.

### BRIEF DESCRIPTION OF THE DRAWINGS

The disclosure is illustrated in the accompanying drawings, in which:

FIG. 1 is a schematic view of a sliding-contact power supply system according to an embodiment of the present disclosure;

FIG. 2 is a cross-sectional view along a D-D direction in FIG. 1;

FIG. 3 is an enlarged schematic view of part E in FIG. 1;

FIG. 4 is a schematic view of a sliding-contact power supply system from another perspective according to an embodiment of the present disclosure;

FIG. 5 is an enlarged schematic view of part F in FIG. 4;

FIG. 6 is a schematic view of a sliding-contact power supply system from another perspective according to an embodiment of the present disclosure;

FIG. 7 is an enlarged schematic view of part G in FIG. 6;

FIGS. 8-10 are schematic views of a sliding-contact power supply system having a fixing support from different perspectives according to an embodiment of the present disclosure;

FIG. 11 is an enlarged schematic view of part B in FIG. 8;

FIG. 12 is an enlarged schematic view of part C in FIG. 8;

FIG. 13 is a partially schematic view of a sliding-contact power supply system according to an embodiment of the present disclosure; and

FIG. 14 is an enlarged schematic view of part M in FIG. 9.

### DETAILED DESCRIPTION

Reference will be made in detail to embodiments of the present disclosure. The same or similar elements and the elements having same or similar functions are denoted by like reference numerals throughout the descriptions. The embodiments described herein with reference to drawings are explanatory, illustrative, and used to generally understand the present disclosure. The embodiments shall not be construed to limit the present disclosure.

In the specification, unless specified or limited otherwise, relative terms such as “center”, “longitudinal”, “lateral”, “width”, “thickness” “front”, “rear”, “right”, “left”, “lower”, “upper”, “vertical”, “above”, “below”, “up”, “top”, “bottom”, “clockwise”, “anticlockwise”, “axial direction”, “radial direction”, “circumferential direction”, as well as derivative thereof (e.g., “downwardly”, “upwardly”, etc.) should be construed to refer to the orientation as then described or as shown in the drawings under discussion. These relative terms are for convenience of description and do not require that the present disclosure be constructed or operated in a particular orientation.

In addition, terms such as “first” and “second” are used herein for purposes of description and are not intended to indicate or imply relative importance or significance. Thus, features limited by “first” and “second” are intended to indicate or imply including one or more than one these features. In the description of the present disclosure, “a plurality of” relates to two or more than two.

In the description of the present disclosure, unless specified or limited otherwise, it should be noted that, terms “mounted,” “connected” “coupled” and “fastened” may be understood broadly, such as permanent connection or detachable connection, electronic connection or mechanical connection, direct connection or indirect connection via intermediary, inner communication or interaction between two elements. Those having ordinary skills in the art should understand the specific meanings in the present disclosure according to specific situations.

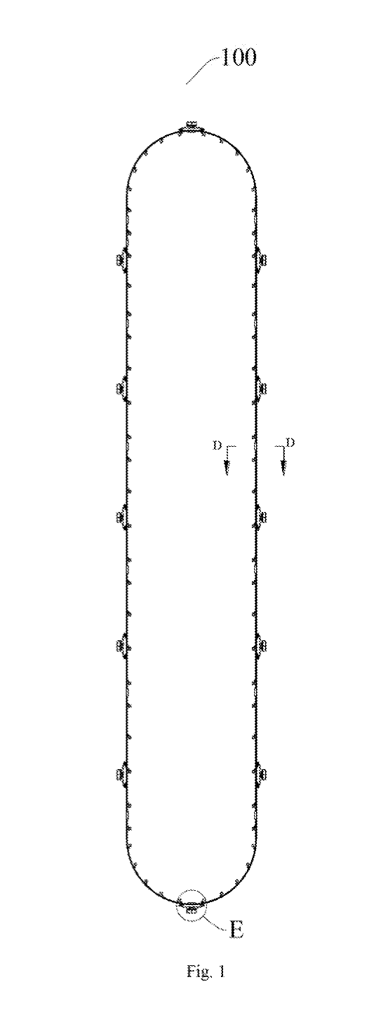

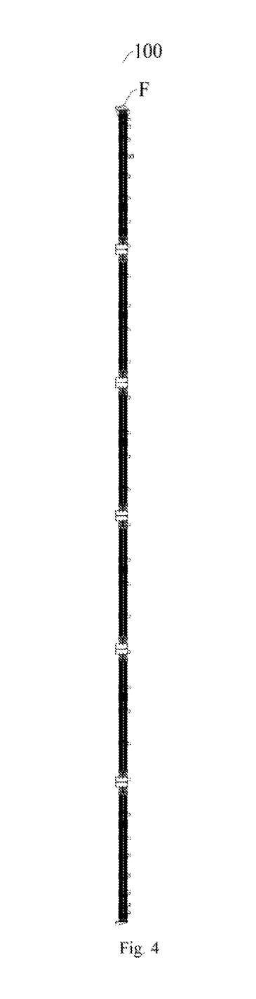

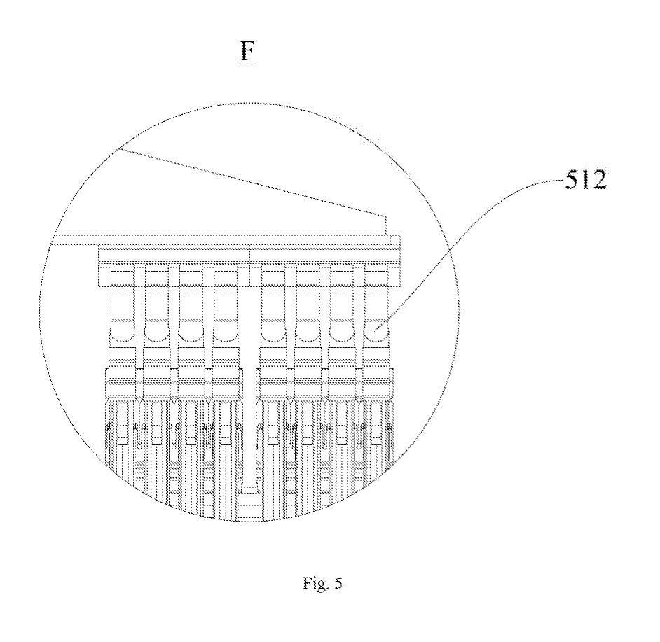

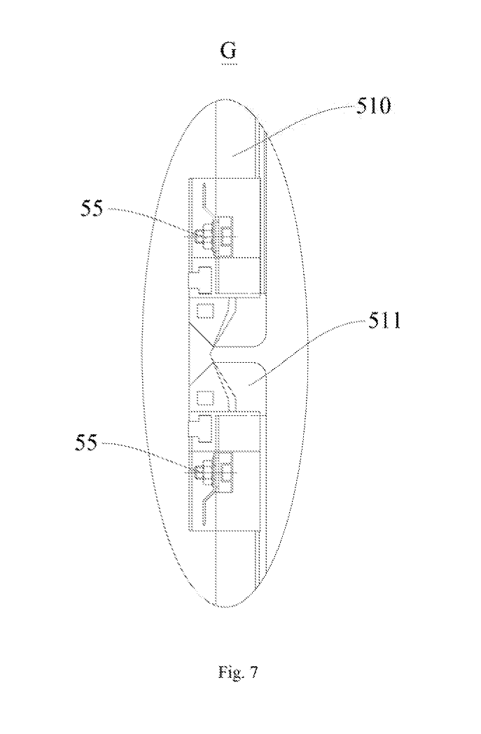

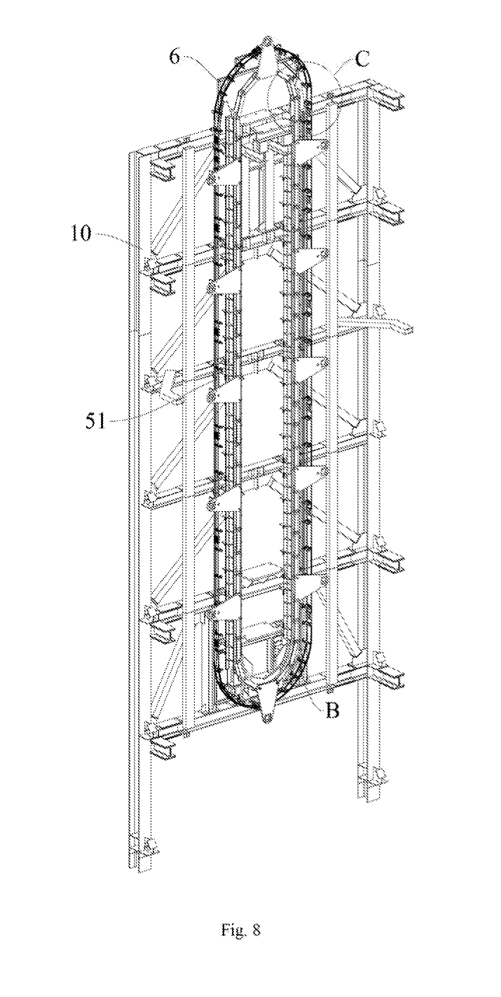

As shown in FIGS. 1-14, a sliding-contact power supply system 100 is provided. The sliding-contact power supply system 100 according to embodiments of the present disclosure may be applied in three-dimensional circulating garages or some other mobile devices that need to obtain current during movement. Those three-dimensional circulating garages or mobile devices may have an electric device, such as a charger, connected to a current collector 52.

As shown in FIGS. 1-7, in some embodiments, the sliding-contact power supply system 100 includes: a plurality of sub-sliding wires 510, a plurality of insulation segmentation elements 511, and a plurality of current collectors 52. Each insulation segmentation element 511 is connected between two sub-sliding wires 510, that is, each two of the plurality of sub-sliding wires 510 are spaced apart from and connected with each other via one insulation segmentation element 511 such that each two sub-sliding wires 510 are insulated and separated from each other by the one insulation segmentation element 511. The plurality of sub-sliding wires 510 and the plurality of insulation segmentation elements 511 form a sliding wire guide rail 51 having a ring shape. Each sub-sliding wire 510 is configured to electrically connect to an outside power supply, that is, the sliding wire guide rail 51 is supplied with power through multiple points, namely in a multi-point power supply manner.

Specifically, the sub-sliding wire 510 includes an electric connection point configured to be connected with the outside power supply. In some embodiments, each sub-sliding wire 510 includes two electric connection points located on two insulation segmentation elements 511 connected thereto respectively. Specifically, in one embodiment, the insulation segmentation element 511 includes two cable connectors 55 configured as the electric connection points of corresponding sub-sliding wires 510.

It should be noted that a part of the insulation segmentation element 511 located between two sub-sliding wires 510 connected therewith should be made of insulating materials, such that the two sub-sliding wires 510 are insulated from each other by the insulation segmentation element 511. And, a part of the insulation segmentation element 511 used for installing the cable connector 55 may be made of conductive materials such that electric current can be easily transmitted into the sub-sliding wire 510.

In some embodiments, each sub-sliding wire 510 has an equal length, and two sub-sliding wires 510 having the equal length are connected with each other via one insulation segmentation element 511. It should be noted that, when the sub-sliding wire 510 is configured as to have an arc shape, the length of the sub-sliding wire 510 refers to an arc length of the sub-sliding wire 510. Thus, a number of elements can be decreased and a manufacturing difficulty of the sliding-contact power supply system 100 can be reduced.

Each current collector 52 is electrically connected with the sub-sliding wire 510, and each current collector 52 is slidably disposed on the guide rail 51. An electricity extracting head 520 of each current collector 52 is slidable on the sub-sliding wire 510 and the insulation segmentation element 511. When sliding on the sub-sliding wire 510, the electricity extracting head 520 can extract electric current from the sub-sliding wire 510.

When the sliding-contact power supply system 100 according to embodiments of the present disclosure is applied into the mobile device, it should be noted that the electric device of the mobile device should be connected to at least two current collectors 52, and at least one current collector 52 is connected with the sub-sliding wire 510 when the mobile device is moving, and thus a condition in which the electricity to the mobile device is cut off can be avoided while the mobile device is being charged.

With the sliding-contact power supply system 100 according to embodiments of the present disclosure, by supplying power through multiple points and multiple segments, an electric current passing through each sub-sliding wire 510 can be reduced, and each sub-sliding wire 510 cannot influence one another, so that the whole system can run normally and safely, and it is convenient for maintenance and troubleshooting of the whole system. And also, a requirement for high-power current of the mobile device can be satisfied.

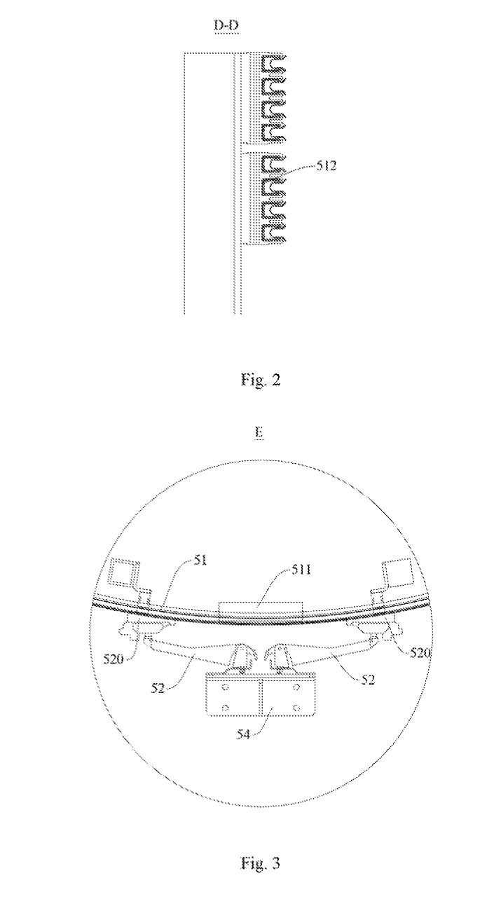

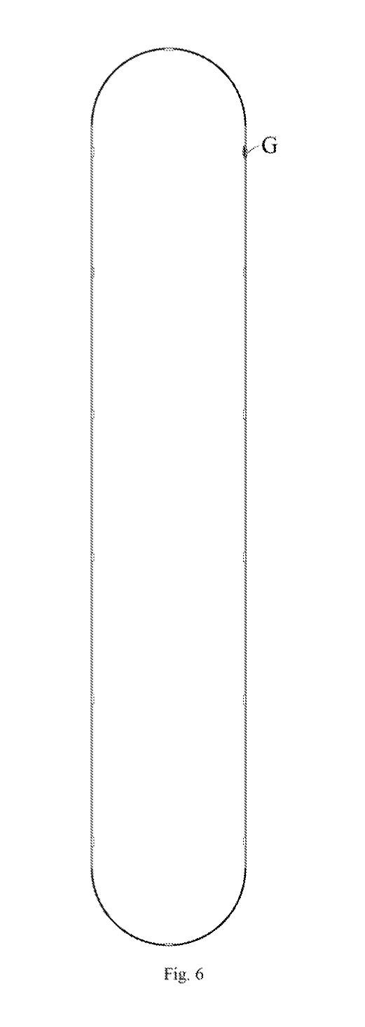

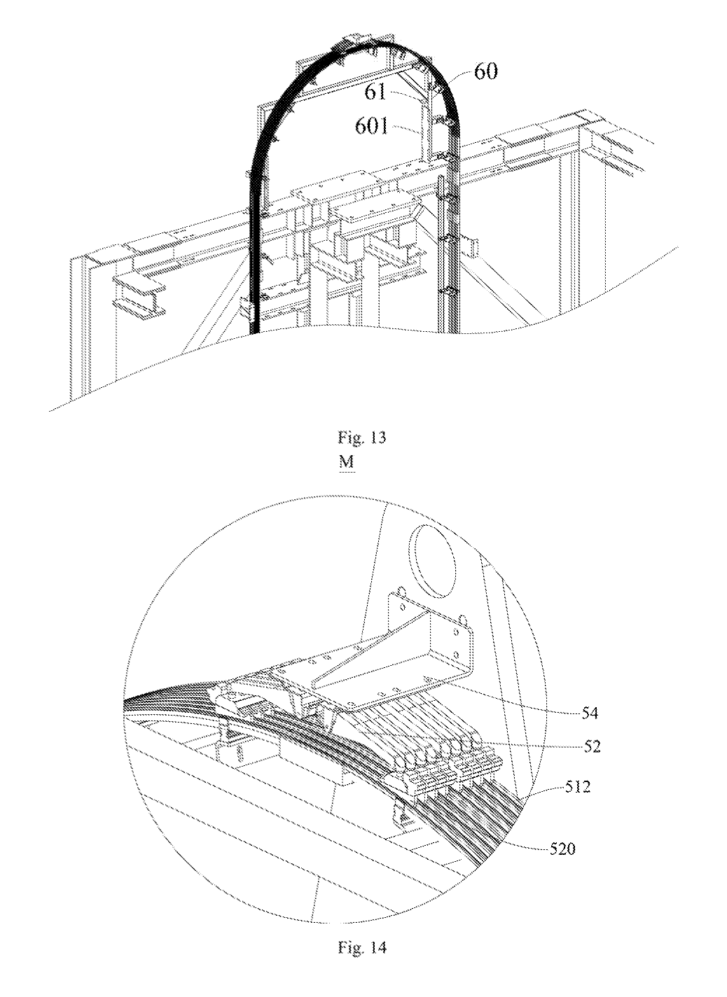

In some embodiments, as shown in FIG. 2, FIG. 5, and FIG. 14, each sub-sliding wire 510 includes a plurality of single-stage sliding contact wires 512, two single-stage sliding contact wires 512 of the plurality of single-stage sliding contact wires are connected with a ground wire and a null line respectively, and other single-stage sliding contact wires 512 of the plurality of single-stage sliding contact wires 512 are connected with a live wire respectively. A row number of the single-stage sliding contact wires 512 can be determined according to actual needs. It should be noted that if each sub-sliding wire 510 includes a plurality of single-stage sliding contact wires 512, each current collector 52 includes a plurality of electricity extracting heads 520. The plurality of electricity extracting heads 520 slides on the plurality of single-stage sliding contact wire 521 respectively so as to electricity current from each single-stage sliding contact wire 512. It should be noted that, when the electricity extracting head 520 slides, a electricity collection principle between the eclectic head 520 and each single-stage sliding contact wire 512 is well known by those skilled in the art, for example, it may be the same as the electricity collection principle between the sliding wire guide rail and the current collector of a traditional sliding wire or conductor bar, and therefore a detailed description thereof is omitted herein.

With the sliding wire guide rail 51 according to embodiments of the present disclosure, each sub-sliding wire 510 includes the plurality of single-stage sliding contact wires 512, so as to reduce the electric current in each single-stage sliding contact wire 512. Also, the number of the single-stage sliding contact wires 512 connected to the live wire may be regulated according to a required electric quantity. Therefore, a stability of the power supply device can be improved, and an early cost can be reduced. In addition, it is convenient for later maintenance and troubleshooting of the power supply device.

In some embodiments, two single-stage slide contact wires 512 of the other single-stage slide contact wires of the plurality of single-stage slide contact wires 512 are connected in parallel with each other and connected with a same live wire. That is, the other single-stage slide contact wires of the plurality of single-stage slide contact wires 512 may be connected with a plurality of live wires, and also two single-stage slide contact wires 512 of the other single-stage slide contact wires connected in parallel with each other may be connected with a same live wire. For example, in one embodiment, each sub-sliding wire 510 includes eight single-stage sliding contact wires 512, six single-stage sliding contact wires 512 of the eight single-stage sliding contact wires 512 are divided into three groups, each group includes two single-stage sliding contact wires 512 connected with each other in parallel, and each group is connected to a live wire of a three phase power source. The other two single-stage sliding contact wires 512 of the eight single-stage sliding contact wires 512 are connected to a null wire and a ground wire of the three phase power source respectively.

In some embodiments, the sliding-contact power supply system 100 further includes a plurality of installation frames 54, two current collectors 52 are disposed on each installation frame 54, and a distance between the electricity extracting heads 520 of the two current collectors 52 disposed on each installation frame 54 is larger than a length of the insulation segmentation element 511. Thus, it is convenient for applying the sliding-contact power supply system 100 in the mobile device and for connecting the electric device of the mobile device to the plurality of current collectors 52.

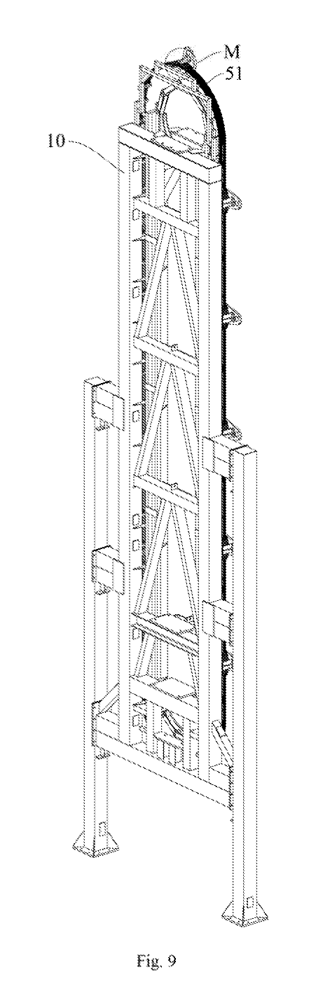

As shown in FIGS. 8-13, in some embodiments, the sliding-contact power supply system 100 further includes a fixing support 10, and the sliding wire guide rail 51 is disposed on the fixing support 10. Thus, the sliding-contact power supply system 100 may be easily applied into mobile device.

In some embodiments, as shown in FIG. 8, the sliding-contact power supply system 100 further includes an expansion and retraction device 6 disposed on the fixing support 10 and moveable in an up and down direction. The expansion and retraction device 6 is connected with the sliding wire guide rail 51 so as to drive the sliding wire guide rail 51 to stretch out and draw back when the expansion and retraction device 6 is moving along the up and down direction. Thus, the three-dimensional circulating garage 100 may be easily assembled and it is easy to regulate the sliding wire guide rail 51 during a using process.

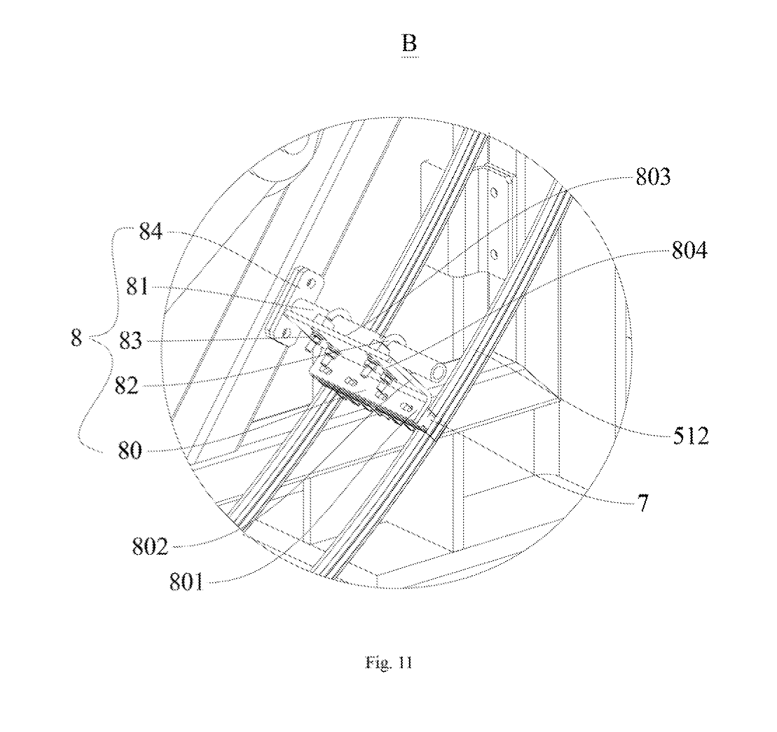

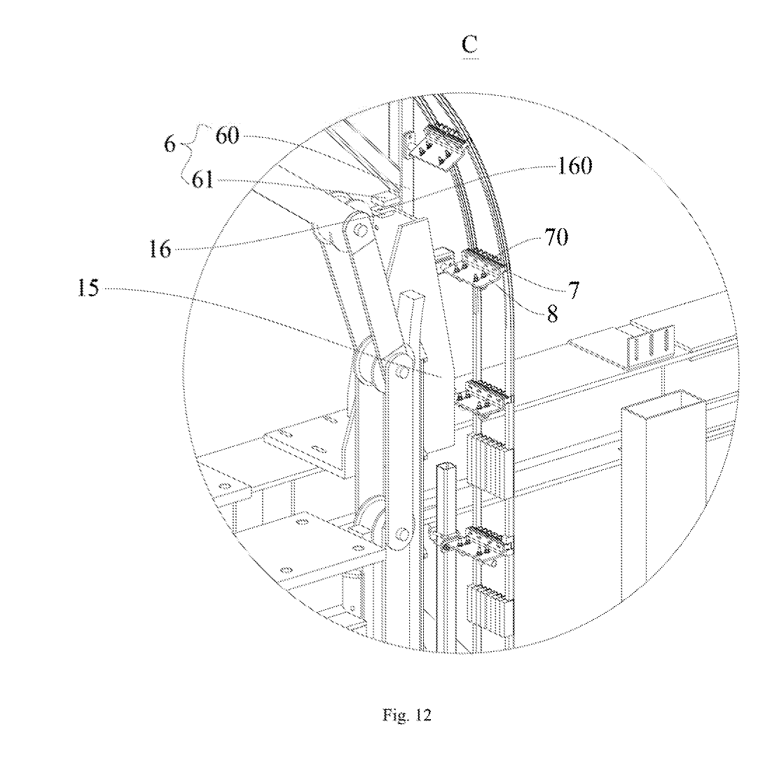

In some embodiments, as shown in FIG. 8, FIG. 12 and FIG. 13, a support frame 15 is fixed on an upper wall of the fixing support 10, and a first regulating plate 16 is disposed on a top end of the support frame 15 and has a threaded hole 160 penetrated therethrough in a thickness direction thereof. In one embodiment, as shown in FIG. 8, there are two support frames 15, and the first regulating plate 16 is disposed on the top end of each support frame 15.

Specifically, a bottom end of the support frame 15 may be fixed on the top wall of the fixing support 10 via welding or screw connection. It should be noted that there are no particular limitations for a shape of the support frame 15. For example, in one embodiment, the support frame 15 has a substantial L shape.

In some embodiments, the expansion and retraction device 6 includes an expansion and retraction frame 60, a second regulating plate 61 and a regulation fixing element (not shown). The expansion and retraction frame 60 is connected with the sliding wire guide rail 51, a regulating hole 601 having an obround shape is formed in a lower portion of the expansion and retraction frame 60, the second regulating plate 61 is disposed on the expansion and retraction frame 60 over the first regulating plate 16, the regulation fixing element passes through the regulating hole 601 and is fixed on the support frame 15. It should be noted that when there are two support frames 15, there are two second regulating plates 61 correspondingly, and the two second regulating plates 61 are disposed on the expansion and retraction frame 60 respectively. The expansion and retraction frame 60 may be configured to be a frame whose bottom is open.

In some embodiments, the sliding-contact power supply system 100 further includes a regulating element (not shown) fitted with the threaded hole 160, an upper end of the regulating element passes through the threaded hole 160 and rests against a lower surface of the second regulating plate 61, such that a distance between the first regulating plate 16 and the second regulating plate 61 can be regulated by regulating a length of a portion of the regulating element stretched out of the threaded hole 160. It should be noted that the length of the portion of the regulating element stretched out of the threaded hole 160 is a length of a portion of the regulating element stretched out beyond the first regulating plate 16.

When an expansion amount of the sliding wire guide rail 51 needs to be regulated, the regulation fixing element is firstly loosen, so that the expansion and retraction frame 60 can move up and down relative to the support frame 15, and then the regulating element is turned to regulate the length of the portion of the regulating element stretched out of the threaded hole 160. As the upper end of the regulating element rests against the lower surface of the second regulating plate 61, the second regulating plate 61 is driven to move up and down by the movement of the regulating element, and thus the expansion and retraction frame 60 is driven to move up and down so as to drive the sliding wire guide rail 51 to stretch out and draw back. Thus the sliding wire guide rail 51 can be regulated.

When the expansion and retraction frame 60 moves to a required position, the regulation fixing element is tighten, and thus the expansion and retraction frame 60 is fixed on the support frame 15 via the regulation fixing element.

With the expansion and retraction device 6 according to embodiments of the present disclosure, by providing the first regulating plate 16, the second regulating plate 61 and the regulating element, it is convenient to regulate an up and down movement of the expansion and retraction frame 60, thus facilitating the regulation of the sliding wire guide rail 51.

In some embodiments, the sliding-contact power supply system 100 further includes a plurality of clamps 7 sleeved on the sliding wire guide rail 51, and a plurality of regulating devices 8 fixed on the fixing support 10 and fitted with the plurality of clamps 7 respectively. Each regulating device 8 is configured to regulate a distance between the clamp 7 fitted therewith and the fixing support 10. Thus, it is convenient to regulate a distance between the sliding wire guide rail 51 and the fixing support 10 such that the sliding wire guide rail 51 can be easily installed.

It should be noted that, as shown in FIG. 12, in some embodiments, when each sub-sliding wire 510 includes the plurality of single-stage sliding contact wires 512, the clamp 7 includes a plurality of clamp grooves 70, and each clamp groove 70 is fitted over one single-stage sliding contact wire 512.

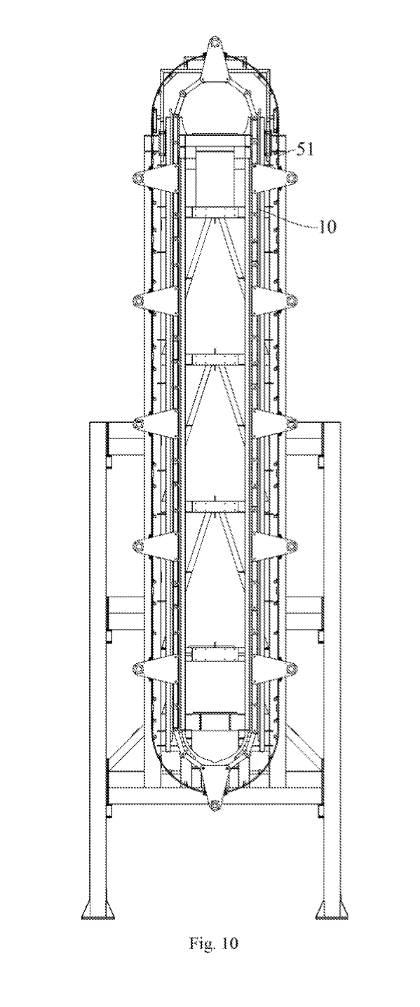

Specifically, as shown in FIG. 11, each regulating device 8 includes an installing plate 80, a regulating column 81 and a positioning element 82. The installing plate 80 is configured to have a substantial L shape and include a first plate 801 and a second plate 802, and the first plate 801 is fixed on a corresponding clamp 7. In some embodiments, the first plate 801 is fixed on the corresponding clamp 7 via a fixing part, such as a screw.

The second plate 802 has a through hole penetrated therethrough along a thickness direction thereof. The second plate 802 includes a first surface 803 and a second surface 804 opposite to each other. In some embodiments, the through hole has an obround shape so as to improve a universality of the regulating device 8.

In some embodiments, a first end of the regulating column 81 is fixed on the fixing support 10 and the regulating column 81 is placed on the first surface 803. In some embodiments, as shown in FIG. 11, the regulating device 8 includes a connecting base 84 fixed on the fixing support 10 via a screw. One end of the regulating column 81 is fixed on the connecting base 84. In one embodiment, the regulating column 81 and the connecting base 84 are integrally formed.

In some embodiments, the positioning element 82 is configured to have a substantial U shape and is fitted over the regulating column 81. Two ends of the positioning element 82 pass through the through hole and are fitted with a regulating nut 83 respectively. The regulating nut 83 rests against the second surface 804 so as to position the positioning element 82. When the regulating nut 83 rests against the second surface 804, the positioning element 82 is fixed on the second plate 802, and thus the regulating column 81 is positioned on the second plate 802 so as to avoid a movement of the regulating column 81.

The distance between the clamp 7 and the fixing support 10 is regulated by regulating a length of a portion of the regulating column 81 placed on the first surface 803. As shown in FIG. 11, in some embodiments, the regulating device includes two positioning elements 82 spaced apart from each other. It should be noted that a number of the positioning elements 82 is not limited to this and may be determined according to actual needs. Thus, the regulating device 8 according to embodiments of the present disclosure has a simple structure and can be regulated conveniently.

In some embodiments, as shown in FIG. 8, the expansion and retraction device 6 and the sliding wire guide rail 51 are connected with each other via the clamp 7 and the regulating device 8. The connecting base 84 of the regulating device 8 is fixed on the expansion and retraction device 6, and the clamp 7 is fitted over the sliding wire rail 51. Thus, a distance between the expansion and retraction device 6 and the sliding wire guide rail 51 can be regulated. Meanwhile, a length of the sliding wire guide rail 51 can be regulated by the expansion and retraction device 6.

In some embodiments, a three-dimensional circulating garage is provided. The three-dimensional circulating garage includes the sliding-contact power supply system 100 mentioned above.

Specifically, the three-dimensional circulating garage further includes a transmission device, a plurality of tray units, and a driving device. Each tray unit includes a vehicle carrying plate configured to place a vehicle. Each tray unit is connected with the transmission device, and the driving device is connected with the transmission device to drive the transmission system to drive the vehicle carrying plate to move reciprocally up and down in a cyclical manner. Each current collector is connected with the transmission device such that the current collector, driven by the transmission device, can slide in the sliding wire guide rail.

Each tray element is provided with a charger configured to charge the vehicle placed on a corresponding vehicle carrying plate. Each current collector is electrically connected with one charger so as to transmit electricity collected from the sliding wire guide rail to the one charger.

With the sliding-contact power supply system according to embodiments of the present disclosure, a safety performance and stability of the three-dimensional circulating garage according to embodiments of the present disclosure can be improved.

Reference throughout this specification to “an embodiment”, “some embodiments”, “an example”, “a specific example”, or “some examples” means that a particular feature, structure, material, or characteristic described in connection with the embodiment or example is included in at least one embodiment or example of the present disclosure. The appearances of the phrases throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

1. A sliding-contact power supply system, comprising:
a plurality of sub-sliding wires, each of the plurality of sub-sliding wires being adapted to be electrically connected to an outside power supply;
a plurality of insulation segmentation elements, each of the plurality of insulation segmentation elements being connected between two sub-sliding wires; and
a plurality of current collectors, each of the plurality of current collectors being electrically connected to the sub-sliding wire,
wherein the plurality of sub-sliding wires and the plurality of insulation segmentation elements define a sliding wire guide rail haying a ring shape, and each current collector is slidably disposed on the sliding wire guide rail.

2. The sliding-contact power supply system of claim wherein each sub-sliding wire comprises a plurality of single-stage slide contact wires, two single-stage slide contact wires of the plurality of single-stage slide contact wires are connected to a ground wire and a null wire respectively, and other single-stage slide contact wires of the plurality of single-stage slide contact wires are connected to a live wire respectively.

3. The sliding-contact power supply system of claim 2, wherein two single-stage slide contact wires of the other single-stage slide contact wires of the plurality of single-stage slide contact wires are adapted to be connected in parallel with each other and connected with a same live wire.

4. The sliding-contact power supply system of claim 1, further comprising a plurality of installation frames, wherein two current collectors are disposed on each of the plurality of installation frames, and a distance between electricity extracting heads of the two current collectors disposed on each of the plurality of installation frames is larger than a length of the insulation segmentation element.

5. The sliding-contact power, supply system of claim 1, wherein the sub-sliding wire comprises two electric connection points respectively disposed in two insulation segmentation elements connected the sub-sliding wire.

6. The sliding-contact power supply system of claim 1, further comprising a fixing support, wherein the sliding wire guide rail is disposed on the fixing support.

7. The sliding-contact power supply system of claim 6, further comprising an expansion and retraction device disposed on the fixing support and moveable in an up-and-down direction, wherein the expansion and retraction device is connected with the sliding wire guide rail so as to drive the sliding wire guide rail to stretch taut and draw back hen the expansion and retraction device moves along the up and down direction.

8. The sliding-contact power supply system of claim 7, wherein a support frame is fixed on a top wail of the fixing support, a first regulating plate is disposed on a top end of the support frame, and the first regulating plate defines a threaded hole penetrated through the first regulating plate in a thickness direction thereof;
the expansion and retraction device comprises a expansion and retraction frame, a second regulating plate and a regulation fixing element, the expansion and retraction frame is connected with the sliding wire guide rail, a regulating hole having an obround shape is formed in a lower portion of the expansion and retraction flame, the second regulating plate is disposed on the expansion and retraction frame above the first regulating plate, and the regulation fixing element passes through the regulating hole and is fixed on the support frame; and
the sliding-contact power supply system further comprises a regulating element fitted with the threaded hole, an upper end of the regulating element passes through the threaded hole and rests against a lower surface of the second regulating plate, such that a distance between the first regulating plate and the second regulating plate is regulated by regulating a length of a portion of the regulating element stretched out of the threaded hole.

9. The sliding-contact power supply system of claim 6, further comprising a plurality of clamps sleeved on the sliding wire guide rail, and a plurality of regulating devices fixed on the fixing support,
wherein the regulating device is fitted with the clamp one to one and configured to regulate a distance between the clamp fitted therewith and the fixing support.

10. A three-dimensional circulating garage, comprising:
a sliding-contact power supply system;
a transmission device;
a plurality of tray units, each including a vehicle carrying plate configured to place a vehicle; and
a driving: device coupled to the transmission device to obtain electricity from the sliding-contract power supply system,
wherein the sliding-contact power supply system comprises:
a plurality of sub-sliding wires, each of the plurality of sub-sliding wires being adapted to be electrically connected to an outside power supply;
a plurality of insulation segmentation elements, each of the plurality of insulation segmentation elements being connected between two sub-sliding wires; and
a plurality of current collectors, each of the plurality of current collectors being electrically connected to the sub-sliding wire,
wherein the plurality of sub-sliding wires and the plurality of insulation segmentation elements define a sliding wire guide rail having a ring shape, and each current collector is slidably disposed on the sliding wire guide rail.

11. The three-dimensional circulating garage of claim 10, wherein each sub-sliding wire comprises a plurality of single-stage slide contact wires, two single-stage slide contact wires of the plurality of single-stage slide contact wires are connected to a ground wire and a null wire respectively, and other single-stage slide contact wires of the plurality of single-stage slide contact wires are connected to a live wire respectively.

12. The three-dimensional circulating garage of claim 11, wherein two single-stage slide contact wires of the other single-stage slide contact wires of the plurality of single-stage slide contact wires are adapted to be connected in parallel with each other and connected with a same live wire.

13. The three-dimensional, circulating garage of claim 10, wherein the sliding-contact power supply system further comprises a plurality of installation frames, two current collectors are disposed on each of the plurality of installation frames, and a distance between electricity extracting heads of the two current collectors disposed on each of the plurality of installation frames is larger than a length of the insulation segmentation element.

14. The three-dimensional circulating garage of claim 10, wherein the sub-sliding wire comprises two electric connection points respectively disposed in two insulation segmentation elements connected the sub-sliding wire.

15. The three-dimensional circulating garage of claim 10, wherein the sliding-contact power supply system further comprises a fixing support, and the sliding wire guide rail is disposed on the fixing support.
